(19) United States
(12) Patent Application Publication
(10) Pub. No.: US 2002/0116301 A1
(43) Pub. Date: Aug. 22, 2002

(54) Automatic consumption based replenishment of supply chain

(75) Inventors: Earl T. Chapman, Rochester, NY (US); Thomas B. Blake, Penfield, NY (US); Matthew W. Street, Cambridge, MA (US); John W. Fandel, Rochester, NY (US)

Correspondence Address: Patent Legal Staff, Eastman Kodak Company, 343 State Street, Rochester, NY, 14650-2201, US

(73) Assignee: Eastman Kodak Company

(21) Appl. No.: 09/745,712

(22) Filed: Feb. 20, 2001

(51) Int. Cl. G06F 17/60

(52) U.S. Cl. 705/29; 705/27

(57) ABSTRACT

A method for automatically updating inventory is provided. A computer network, including one or more servers which are adapted to be accessed by a plurality of clients over the network can be provided. A record of the use of a product may be created when the product is used. The record can then be provided to the client. The record can be transmitted from the client over the network to the server and is received at the server. The record may be parsed at the server to identify the products and a number of those products used. An inventory record in a database can be updated to reflect the use of the products, resulting in a current inventory level. The current inventory level may be retrieved from the database. Consumption reports, including the current inventory level of products, can be provided from the server to the client.

### FIELD OF THE INVENTION

The present invention relates to automated business transactions, and more particularly to a system and method for automatically replenishing inventory and controlling a manufacturing process.

### BACKGROUND OF THE INVENTION

In order to improve customer satisfaction and production efforts, there has been a focused effort to increase sales and improve the effectiveness of supply chains. It has become clear that one of the critical success factors in improving customer satisfaction is the order to cash transaction process. The main opportunities for improvement in customer satisfaction for these customers is in order placement, shipping and delivery, value for price paid, ease of doing business and product availability.

In a typical scenario, a supplier supports several customers that sell or use the supplier's products. The customers usually keep an inventory of products to satisfy demand. As products are used or sold, the customers place orders with the supplier to replenish their inventory. In many cases, the supplier may also be a manufacture of the products. Since manufacturing requires some lead-time, the supplier may maintain an inventory from which they can supply their customers.

In today's typical environment, purchaser's orders are satisfied through a combination of on-hand inventory and on-demand order placement. Required turnaround time for purchasers from the customer continues to shrink, and therefore customer service becomes closely tied to the supplier's ability to quickly satisfy customer demand. Because of this increasing competitive pressure to provide quick delivery response, particularly for suppliers with a diverse product portfolio, the supplier is forced to hold large finished goods inventories to buffer against demand uncertainty.

Manufacturing of the products by the supplier has traditionally been planned based on forecasted orders that customers will place on the supplier. For example, the supplier may sell products to its customers through its sales organization. These products currently are ordered by the customers through a manual process, wherein the customer contacts its sales representative, and then the representative enters the orders in the supply systems. The order is then fulfilled.

Because customers often carry inventory and consume products out of this inventory over time, the customer ordering signal does not provide a clear picture of how the supplier's products are actually being used on a daily basis. As customers accumulate their consumption over time, and then place an order, a large gap in time is created between order placement for a given product and the point at which the customer actually used the product. When multiple customers behave similarly, the supplier sees a great deal of variability on demand, and buffers against this with finished goods inventory.

In this environment, the supplier lacks the ability to see customer usage of products, —the supplier only sees the orders placed. Thus, there is a need for a method and system to bridge this gap by collecting a usage signal as customers consume products, then sending this information back to the supplier. With this signal, the supplier can then replenish the customers' usage without the customer even needing to place an order themselves.

### SUMMARY OF THE INVENTION

The present invention can provide a consumption based product replenishment system and method. Customers may create a record of use of a product as the product is consumed. In an exemplary embodiment, the record is received at a manufacturer and evaluated. Preferably, the record is received on at least a daily basis. The evaluation may include determining the number and type of products consumed, as well as the date of use. The manufacture of replacement product can be done based on the evaluation.

A manufacturing system including one or more servers which are adapted to be accessed by a plurality of clients over a network can be provided. Customers can communicate via the client with a supplier on the server side. Each customer may create a record of use of the products. The record should indicate when the products are used. According to a method for managing manufacturing products, the records can be forwarded to the supplier on at least a daily basis. The records can be evaluated for all customers at the server. A manufacturing schedule for the supplier can be formulated based on the evaluation.

According to one embodiment of the invention, a method and system for automatically ordering products based on consumption is provided. A computer network, including one or more servers which are adapted to be accessed by a plurality of clients over the network can be provided. A record of the use of a product may be created when the product is used. The record can then be provided to the client and transmitted via over the network to the server. The record may be parsed at the server to identify the products used, as well as a number of each product used. An inventory record in a database, which may be accessed by the server, can be updated to reflect the use of the products, resulting in a current inventory level. Consumption reports, including the current inventory level of products, can be provided from the server to the client so that a customer can view product usage. Additionally, usage of products may initiate an automatic ordering process to replenish the customer's inventory.

In a product replenishment system including one or more servers which are adapted to be accessed by a plurality of clients over a network, customers being able to communicate via the client with a supplier on the server side, another embodiment of the invention provides a method and system for managing manufacturing of products. Each customer may create a record of use of products at a time the products are used. The records can be transmitted via the client to the supplier, preferably at least on a daily basis. Based on the daily reports, usage at the server can be updated for each customer. The usage history for all customers can then be evaluated by the supplier. Based on the evaluation, the supplier can adjust a manufacturing schedule for the various products.

In another embodiment, the invention may include a computer useable information storage medium storing computer readable program code. The code can cause a computer to receive a record of use of products at a manufacturer, determine types of products used based on the record, determine a date of use of the products based on the record, determine a number of each type of product used, and plan manufacture of the types of products based on at least one of the number of each type of product used and the date of use of the product.

In an exemplary embodiment, the present invention provides an auto-replenishment program that may be based around a method and system that can include an off-the-shelf barcode scanning device, software to download the scanned data from the device, and a database on a network server to collect the data. The database/server may also used to post data to a secure customer website, place a product order for the customer, and initiate an electronic funds transfer transaction to complete the payment process.

By understanding actual customer consumption of products on a daily basis, for example, instead of only understanding customer orders on a much more infrequent basis, the variability of demand on the supplier's manufacturing resources can be reduced significantly. Additionally, because the signal may arrive electronically, the order can be placed without manual intervention on the supplier end, thus further streamlining the ordering process. Finally, with electronic transfer of funds from the customer to the supplier at time of shipment, the Days of Sales Outstanding (DSO) will also be reduced dramatically.

From the customers' perspective, manual ordering of products can occur only on a special-case basis. Instead of ordering product, the customer may scan products as they are used, and the supplier can replenish this usage automatically. The customer can be more assured that product will always be available, and they can eliminate most of the manual transactions associated with ordering from and paying the supplier. Moreover, product usage, and thus inventory, can now be tracked electronically, where in the past, manual inventory checks were made to keep track of product flow and availability.

The invention and its objects and advantages will become more apparent in the detailed description of the preferred embodiment presented below.

### BRIEF DESCRIPTION OF THE DRAWINGS

FIG. 1 is a schematic of a system according to an embodiment of the invention;

FIG. 2 is a flow diagram showing data uploading from the client according to an embodiment of the invention;

FIG. 3 is a flow diagram of data uploading at the server according to an embodiment of the invention;

FIG. 4 is a flow diagram of data processing according to an embodiment of the invention;

FIG. 5 is an example of an order entry screen according to an embodiment of the invention;

FIG. 6 is an example of an order status screen according to an embodiment of the invention;

FIG. 7 is an example of a consumption report according to an embodiment of the invention; and

FIGS. 8-20 show the order status screen, the order entry screen and the consumption report according to an exemplary scenario.

### DETAILED DESCRIPTION OF THE INVENTION

The present invention can provide a system and method for automatic inventory replenishment. The system, and method can automatically replenish stocked inventory as it is used. The system and method may track products, provided by a supplier, as a customer uses them. Information regarding use of the products can be transmitted to the supplier. By tracking product use in this manner, the supplier is able to automatically track the product usage of the customer. Thus, products may be automatically ordered when needed to replenish the products used by the customer, with no action needed by the customer. Furthermore, the supplier now has information regarding the rate at which its customers are using products. By evaluating product use data from a number of customers, the supplier may be able to gauge demand and adjust manufacturing and their own inventory appropriately. This feature is particularly useful for an environment in which a supplier has several large customers, which account for a large portion of the supplier's sales.

According to an exemplary embodiment, as the customer uses products, information about the usage of the product, such as the type of product and the date of use of the product, can be recorded. A record of the use of the products is preferably generated as the products are used. This can be done, for example, by scanning barcodes of products as they are removed from the customer's stock room. This record should then be provided to the supplier, preferably at least on a daily basis.

The supplier should have and maintain information regarding the customer's consumption of the products, for example, in a database. Additionally, the customer's inventory level may be tracked and updated by the supplier based on the information about the usage of the products. Simply subtracting the number of products used from the current inventory level can accomplish the updating. Accordingly, the customer does not need to track their inventory. The inventory and usage history may be tracked automatically by the supplier and provided to the customer.

Additionally, the supplier can use the current inventory level and information regarding product usage to automatically replenish the customer's stock. The supplier can monitor products used based on the records of product usage received. As the customer's stock becomes depleted, the supplier can be aware of this fact. The supplier may then determine when to order more product for the customer. This determination may be made based on predetermined business rules, some examples of which are described below. When it is determined an order should be placed, the order can be entered directly into the supplier's order systems. Thus, no input by the customer is necessary for ordering. In a preferred embodiment, the customer can select those products that are to be automatically replenished. This information should be stored in the database.

Additionally, providing the supplier with a record of product usage allows the supplier to track the consumption of products by the customer. This information may be made available to both the customer and the supplier via the network. Upon request from the customer, consumption reports can be generated. These reports may show the customers use of products and can be broken down by various characteristics, for example, products used on particular dates or over periods of time. The customer may also be given the ability to view and modify their order before the order is placed and automatically replenished.

The supplier may also make further use of the record of product usage. By tracking the use of products by its customer, the supplier can have first hand knowledge of their customer's history of product consumption. The supplier may evaluate product use and inventory information from different customers to reliably predict when orders for certain products will be forthcoming. Thus, the supplier will not be taken off guard by receiving several large, unexpected orders at once or need to stockpile large quantities of goods in their warehouse to meet unexpected demand. The supplier can evaluate their customers' product use and adjust their manufacturing and inventory accordingly. For example, products that are being used heavily may require the supplier to increase production and/or their inventory in those products. Conversely, products that are being used lightly may allow the supplier to reduce their inventory and scale back production. By tailoring manufacturing and inventory to customer use, the supplier can reduce their costs and expenses and reduce demand variability on its manufacturing facilities.

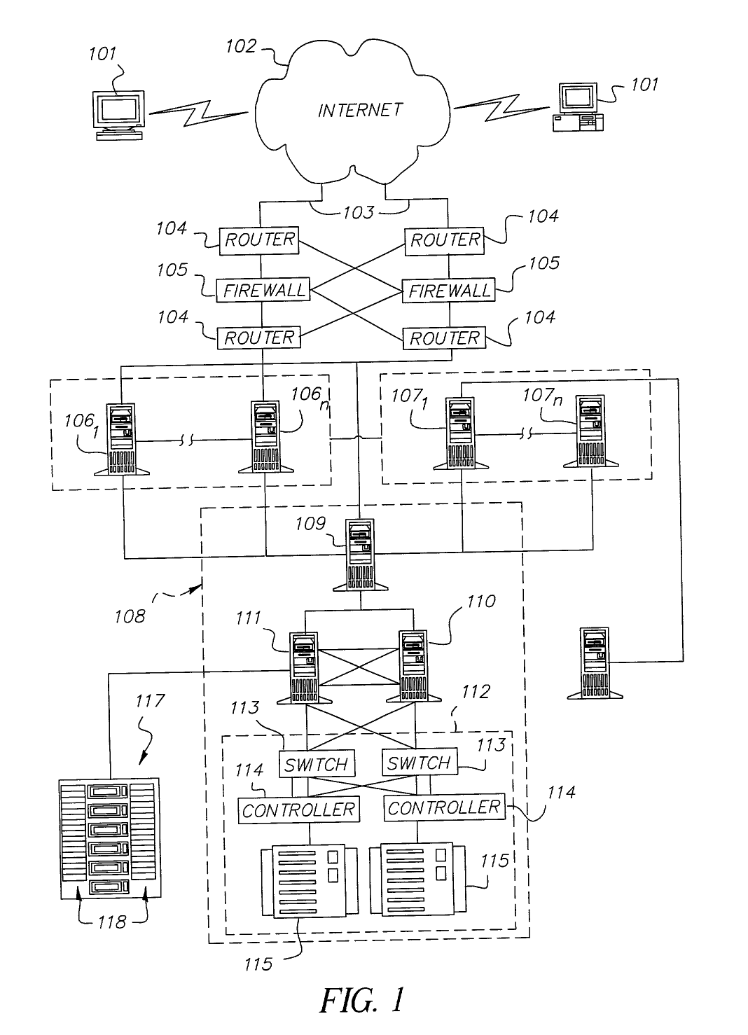

The method and system are preferably implemented in a computer network environment and are described below in a preferred embodiment in that context. Of course, the invention can be used in other environments. In one embodiment, the present invention may be implemented as a software application. The software application may be a part of the supplier's inventory and ordering system. The software application may execute on application servers provided in a typical three-tiered architecture. In this architecture, the software application is provided via a web site. FIG. 1 is a schematic diagram of a system 100 that can provide automatic inventory replenishment and manufacturing control.

System 100 is adapted to be accessed by a plurality of clients 101. Such clients 101, in turn, suitably comprise one or more conventional personal computers and workstations. It should be understood, nevertheless, that other clients 101 such as Web-enabled hand-held devices (e.g., the Palm V™ organizer manufactured by Palm, Inc., Santa Clara, Calif. U.S.A., Windows CE devices, and “smart” phones) which use the wireless access protocol, and Internet appliances fall within the spirit and scope of the present invention.

Clients 101 of all of the above types suitably access system 100 by way of the Internet 102. By use of the term “Internet”, it should be understood that the foregoing is not intended to limit the present invention to a network also known as the World Wide Web. It includes intranets, extranets, Virtual Private Networks (VPNs), and the like. In any case, a pair of Internet access lines 103 (e.g., primary and shadow conventional T3 lines) are cross-connected from the Internet 102 backbone to one or more, and preferably, a pair of redundant routers 104. Incoming traffic from the first of such routers 104 is then suitably directed through a firewall 105 to the second of such routers 104. Even more preferably, and for the sake of redundancy, two firewalls 105 are cross-connected as shown in FIG. 1. A presently preferred router 104 is the SmartSwitch Router 8000, which is manufactured by the Enterasys Networks division of Cabletron Systems, Andover, Mass. U.S.A. Moreover, a presently preferred firewall 105 is an IP network application platform (e.g., the IP650, IP440, or IP330 firewall platforms, which are manufactured by Nokia Group, Espoo, Finland).

A plurality of web servers 106₁, 106₂, . . . 106ₙ, is, thus, conveniently load balanced by use of the foregoing configuration. That is, the load of incoming traffic from the Internet 102, through the routers 104 and firewalls 105, is balanced among each of the web servers 106₁, 106₂, . . . 106ₙ, such that: (1) certain incoming traffic is routed to a particular web server 106₁, 106₂, . . . 106ₙ, where that particular web server 106₁, 106₂, . . . 106ₙ had been recently used by a given user whose information had been cached on that particular web server 106₁, 106₂, . . . 106ₙ, and, as a result, it would be more efficient to continue to use that particular web server 106₁, 106₂, . . . 106ₙ; or (2) no single one of the web servers 106₁, 106₂, . . . 106ₙ would become overburdened.

In a preferred embodiment of the present invention, there are several such web servers. Each of the web servers 106₁, 106₂, . . . 106ₙ is, in turn, preferably comprised of a Dell™ PowerEdge™ 2450 server (manufactured by Dell Computer Corporation, Austin, Tex. U.S.A.), with a 733 MHz Pentium III processor, 256 MB RAM, and dual, mirrored 9.1 GB fixed disk drives. Preferably, each of the web servers 106₁, 106₂, . . . 106ₙ further comprises a Microsoft® Windows® NT operating system, and Netscape Enterprise Server, Release 3.6.3 (developed by Netscape Communications, a subsidiary of America Online, Inc., Dulles, Va. U.S.A.). Optionally, Netscape's Certificate Server may also be installed on each of the web servers 106₁, 106₂, . . . 106ₙ to facilitate core digital certificate-issuance and management services, as well as distribution of certificates and certificate-revocation lists to clients and other servers. Other forms of certificate servers (e.g., web certificate servers and wireless certificate servers, which are available from VeriSign, Inc., Mountain View, Calif. U.S.A.) may likewise be deployed on each of the web servers 106₁, 106₂, . . . 106ₙ.

System 100 further comprises a plurality of application servers 107₁, 107₂, . . . 107ₙ, coupled to the web servers 106₁, 106₂, . . . 106ₙ. In the preferred embodiment of the present invention, there are several such application servers. Each of the application servers 107₁, 107₂, . . . 107ₙ is, like the web servers 106₁, 106₂, . . . 106ₙ, preferably comprised of a Dell PowerEdge 2450 server, with a 733 MHz Pentium III processor, 256 MB RAM, and dual, mirrored 9.1 GB fixed disk drives. Preferably, each of the application servers 107₁, 107₂, . . . 107ₙ, further comprises a Microsoft Windows NT operating system. At the same time, a load balancer is loaded on each of the web servers 106₁, 106₂, . . . 106ₙ, to facilitate balancing of the load of communications between each of the web servers 106₁, 106₂, . . . 106ₙ and each of the application servers 107₁, 107₂, . . . 107ₙ.

Beneath the layer of web servers 106₁, 106₂, . . . 106ₙ, and application servers 107₁, 107₂, . . . 107ₙ, is a storage area network (SAN) 108. SAN 108 generally comprises a cluster server 109 that is connected to receive incoming Internet traffic through each of the application servers 107₁, 107₂, . . . 107ₙ, and to transmit outgoing Internet traffic through the routers 104 and firewall 105, from the SAN 108 by way of either a file server 110 or a database server 111.

As seen in FIG. 1, the hardware comprising system 100 is substantially completed with the addition of high-availability storage 112 cross-connected to the file server 110 and database server 111. One suitable such high-availability storage 112 comprises the fiber channel switches 113, a pair of disk controllers 114, and a pair of disk arrays 115. Each of the disk controllers 114 preferably comprises a SCSI controller (e.g., a Symbios® SYM53C1010 Ultra160 SCSI controller, manufactured by LSI Logic Corporation, Milpitas, Calif. U.S.A.). In a presently preferred embodiment, the disk arrays 115 each comprise twenty 36GB LVD (i.e., low voltage differential) disk drives which are configured to be mirrored RAID 5. Suitable such LVD drives are, for example, the Ultrastar 36ZX hard disk drives manufactured by IBM Corporation, Armonk, N.Y. U.S.A.

System 100 further comprises a tape library 116, which includes a plurality of advanced intelligent tape drives 117 (preferably AIT2 tape drives) and a plurality storage positions 118 for the AIT2 tapes. In a presently preferred embodiment, the tape library 116 comprises a TLS-4000 automated tape library (manufactured by Qualstar Corporation, Canoga Park, Calif. U.S.A.), which can incorporate up to 12 AIT2 tape drives and has storage for at least 60 AIT2 tapes. Such tape library 116 furthermore preferably comprises suitable software (e.g., Veritas Netbackup™) to control reading and writing of data to the tape library 116.

A software process that takes receipt of HTTP requests preferably runs on web servers 106₁, 106₂, . . . 106ₙ. The web servers 1061, 1062, . . . 106ₙ, either handle the requests or forward them to other software/systems for handling. The software application preferably runs on the application servers 107₁, 107₂, . . . 107ₙ behind the web-servers. The web servers forward appropriate requests to the application servers for processing. Responses to such requests are generated by the application servers and are passed back through the web server to the requesting client. The general manner in which this process occurs is well-known to one skilled in the art and is not described in more detail here.

As mentioned above, the present invention may be implemented as software applications running on the client, the server, or both the client and server. The software applications may provide various interfaces, such as web pages, for a customer to interact, via the client, with the server. For example, the client may access, via a uniform resource locator URL, a web site to log into the automatic inventory replenishment system. An authentication and security system, such as those known to one skilled in the art which require user IDs and passwords, may be provided to prevent unauthorized access the web site and to a customers information. After a customer has logged in, various options according to different features of the invention may be provided. For example, options such as uploading inventory information about the usage of products and modifying an order may be provided. These options can be provided to the client via web pages.

Along these lines, the customer may view a report of their consumption of products and the status of orders. The information can be accessed from the database by the server and provided to the client via web pages. These reports may include the amount of product consumed during a specified period of time, a subtotal of scanned quantities since the last product shipment, a breakdown of products scanned that are not on the replenishment program, calculated inventory levels, the amount of items in the last product shipment, and the accumulation of items if a minimum order quantity has not yet been met. A software application running on the server preferably can generate these reports based on the product usage records. Additionally, a web page allowing customers to modify the order quantities for products can be provided.

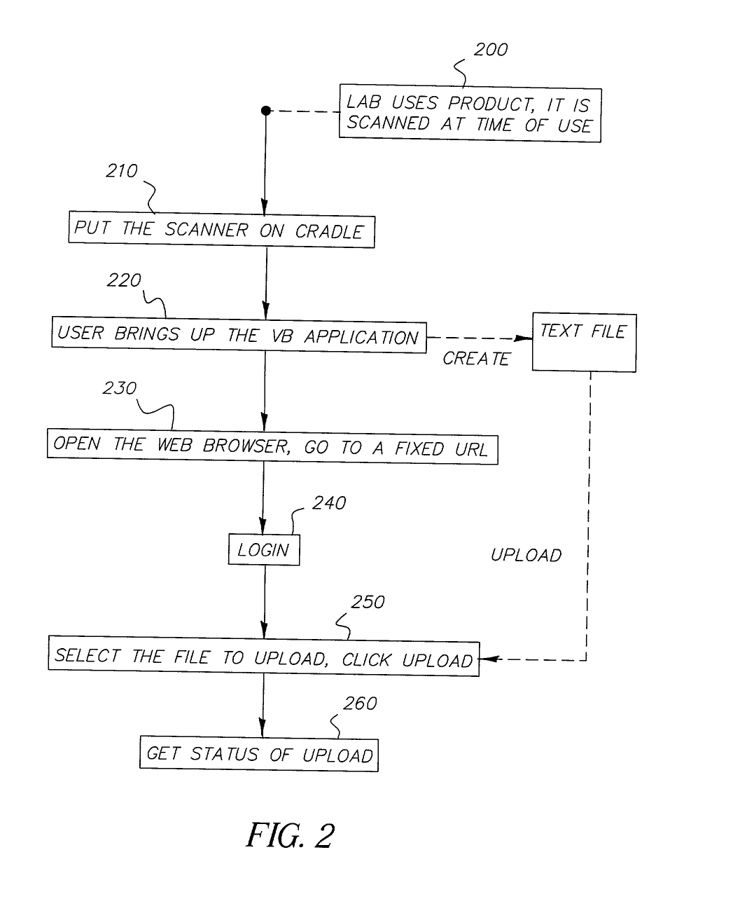

Turning now to FIG. 2, a method for automatically replenishing inventory according to an exemplary embodiment of the invention will be described. A first part of this embodiment includes tracking the usage of products by at the customer. A catalog of supplier products that may be used by the customers should be stored in the database. As mentioned above, product usage information can be captured, preferably at the time the product is used, step 200. The information capture may be accomplished by scanning a bar code of the product with a scanner as the product is removed from inventory or by an existing point of sale system. The information captured by the scanner should include a serial number of the scanner, if used, a time/date stamp, and the UPC or other code for the product. Preferably all products used by a customer are scanned, even if the product is not manufactured by the supplier.

Once the product usage information is collected, it can be transferred from the scanner or other device to the client device in step 210. For example, if a hand-held scanner is used, the scanner can be placed into a cradle attached to the client device. The client device should include a means for retrieving the information from the scanner, step 220. The client device may have an application installed on it for this purpose or an applet or an application may be provided from the server for information retrieval. The application may be, for example, a Visual Basic application residing on the client or a Java applet provided over the computer network. The software application preferably converts the retrieved information into a text file.

In order to provide the retrieved information to the server to be processed, the client should connect to the web site, steps 230-240 depending upon the particular implementation, the order of these steps can vary. If the application for retrieving information from the scanner is provided from server, the client device would open a web browser, for example, and, after logging in to the web site, go to a fixed URL which would provided the application to the client device. The application can then read the information stored in the scanner and creates the text file. If an application residing on the client device is used, the text file may be created before logging onto the web site. The text file to be uploaded can be selected and then uploaded to the server, per step 250. In step 260, the server can report the status of the upload to the client. In a preferred embodiment, product usage information is uploaded at least daily.

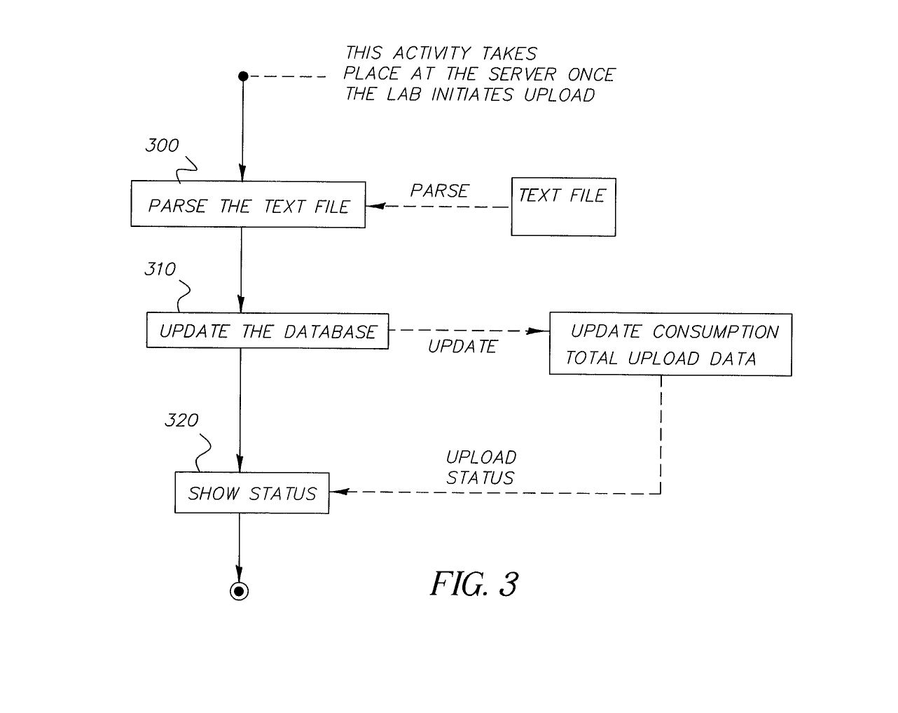

After the upload from the client device, the server can process the uploaded file. FIG. 3 shows an example of data uploading from the client according to an embodiment of the invention. After a file is selected and uploaded, an application running on the server parses the text file, step 300. The parsed text file is evaluated to associate it with products in the supplier's catalog. For example, the UPC code can be associated with a product description and catalog number. This data can be used later for automatic reordering. If the supplier does not manufacture the product, the customer can be prompted to enter a description at the item so the product may be recognized in the future. The information about the scanned products should be populated in the database and can also be used to update the customers inventory, step 310.

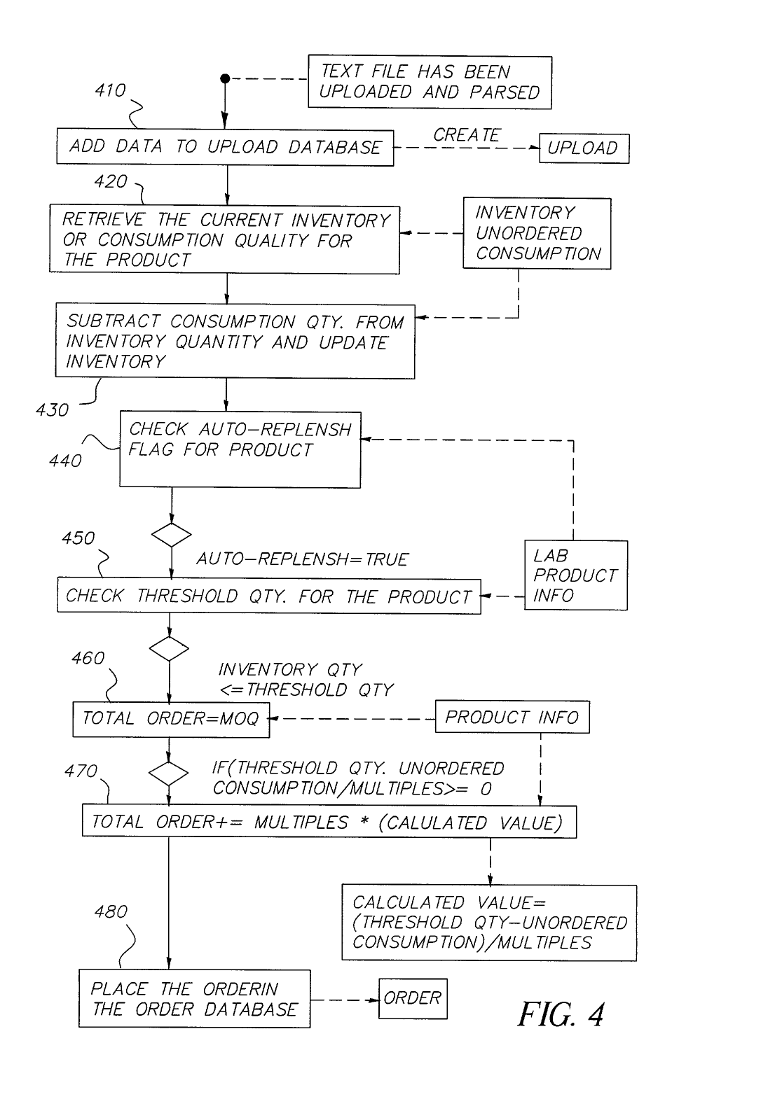

After the data is upload to the server, it may be used to calculate usage and order information. FIG. 4 is a flow diagram showing the calculation of the inventory and order information according to an exemplary embodiment of the invention. The text file generated in step 400 has previously been parsed. The data resulting from parsing can be added to the database, step 410. Preferably, the most recently uploaded data is temporarily stored in an upload database. The inventory from the database for the products, in the upload database can be retrieved, step 420. The amount of product consumed as determined from the uploaded data may then be subtracted from the inventory stored in the database, step 430. This result can then be stored in the database as the current inventory level and replace the previous inventory level.

As previously discussed, the customer can select to automatically replenish their inventory. The replenishment can be done based on consumption. The customer can be given the option of selecting products to be automatically replenished. This information should be stored in the database. In step 440, it is determined if the customer has selected the automatic replenishment option for the particular product being processed. Checking the database for the information regarding that particular customer can do this. If the automatic replenish option has been selected, the method proceeds to step 450 .

Step 450 begins the process for determining an order quantity. The order quantity may be determined based on predetermined business rules. The supplier and customer can agree upon the business rules before hand. For example, the customer can specify when the inventory for a product falls below a threshold, the product shall be reordered etc. The business rules for each customer can be stored in the database. Of course, business rules other than those discussed here can be used to determine the order quantity. The business rules in this example require that the current inventory level fall below the threshold level before an order is placed. When determining to replenish a product, the threshold level for a particular product can be specified by different customers and stored in the customer database. The threshold quantity for that product is obtained from the database, step 450. If the current inventory quantity is less than or equal to the threshold quantity an order amount should be calculated. Here, a minimum order quantity (MOQ) is specified as the minimum amount of that product that can be ordered, step 460. This value is used as the basis for calculating an order quantity. The order amount can then be calculated based on the MOQ and other business rules, step 470. After the order amount has been calculated, it is stored in the database and the order may be placed, step 480.

The customer may have the opportunity to review, update and submit the order data before it is automatically submitted. The customer can access updated inventory information by selecting the appropriate link on a web page. The customer may have access to this information via the Internet at virtually any time or location. Upon receiving a request for order information, information is then retrieved from the database. A report, such as those described below, can be generated and sent by the server to the client, for viewing by the customer. The customer is then provided the opportunity to modify the order data. This may be done by simply changing the order amount displayed in the report. After any modifications are made, the customer can then submit the modified order data, for example, by clicking on a submit button. The modified order is then transferred to the server and stored in the database, replacing the previous order.

The business rules also allow the customer to specify when orders are finalized and processed. That is, certain dates or times can be selected to submit orders. For example, a large volume customer may want orders submitted twice a week. Thus, the business rules may specify trigger dates/times, such as, Wednesday and Friday at the close of business, on which the system is to submit all orders for that customer. At those times the order quantity, for products in the auto replenishment program are ordered. Accordingly, any changes that the customer wants to make to the order quantity should be to be made before the trigger date/time.

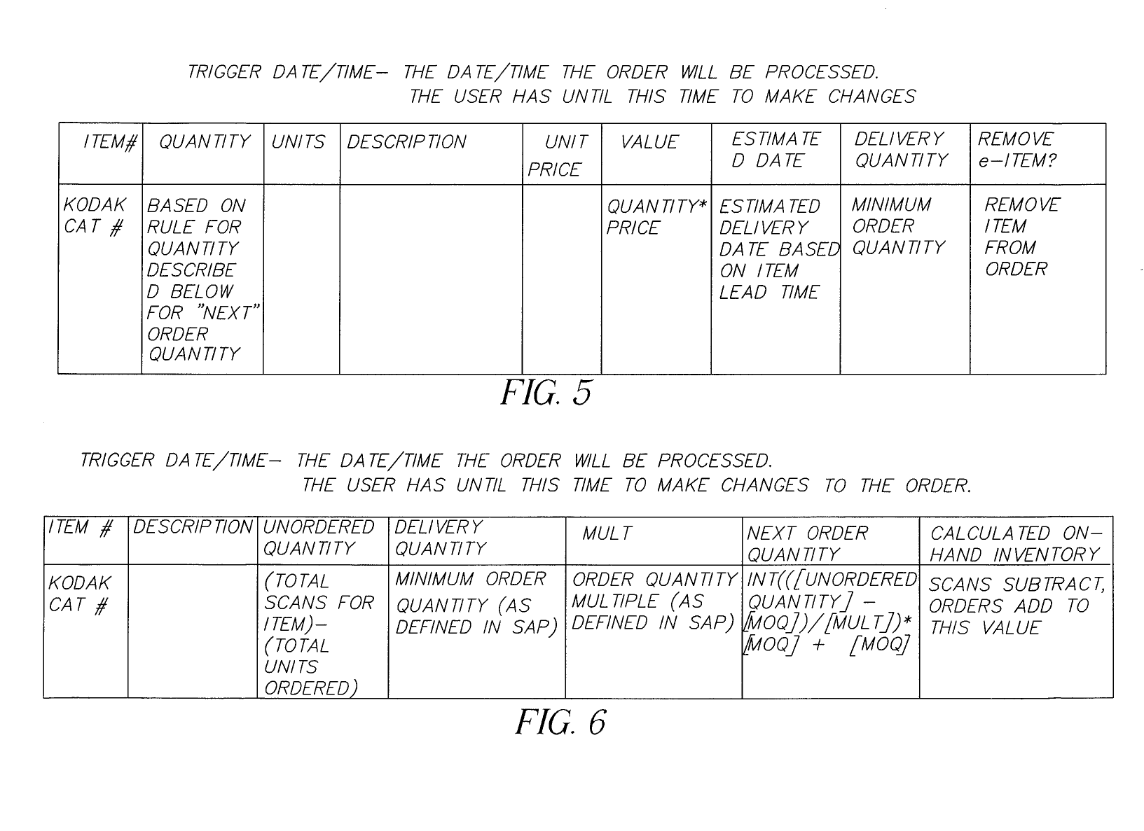

Turning now to FIGS. 5-7, various information that may be displayed to the customer via the above described web pages are shown. FIG. 5 shows an example of an order entry screen. The information displayed in this screen is the information upon which the next order will be based. Above the table, a trigger date/time for submitting the order is displayed. As mentioned above, the trigger date/time indicate the date and time the order will be processed by the server. The customer may make changes to the order until this time. The table may also include columns for listing the item number, quantity, units, description, unit price, value, estimate delivery date, and delivery quantity for each item. This information can be retrieved from the uploaded text file after parsing. A column for removing any item from the order may also be provided. The item number may simply be a catalogue number for the product in the supplier's catalog. The quantity of products shown in the table may be determined based on a rule used for calculating a next order quantity, which rule is described below. A description of the product is given in the description column, along with the corresponding price in the unit price column. The total cost for the order quantity is shown in the value column. An estimated delivery date can be calculated based on item lead time and displayed in the estimate delivery date column. The amount of items in the next order is shown in the delivery quantity column (MOQ).

FIG. 6 shows an example of an order status screen. The information displayed in this screen is based upon the next scheduled shipment in the automatic replenishment program. Again, the trigger date/time is displayed at the top of the table and the item number and description are included in the table. The unordered quantity shown in the table is the amount of product used that has not been ordered. This quantity may be equal to the amount of a product used, determined based on the number of scans for an item, minus the amount of units that have previously been ordered. The minimum order quantity is again shown as the delivery quantity as in the previous FIG. (5). An order quantity multiple is shown in the multiple column. The order quantity multiple may be defined in an enterprise resource planning program such as SAP. The next order of quantity, which is shown both this table and the previous table, may be calculated based on the business rules. For example, the business rules can define the next order quantity as ((unordered quantity−MOQ)/MULT) * MOQ+MOQ. The calculated on-hand inventory can be calculated by taking the current amount of inventory minus the amount of product used based on the scanned information.

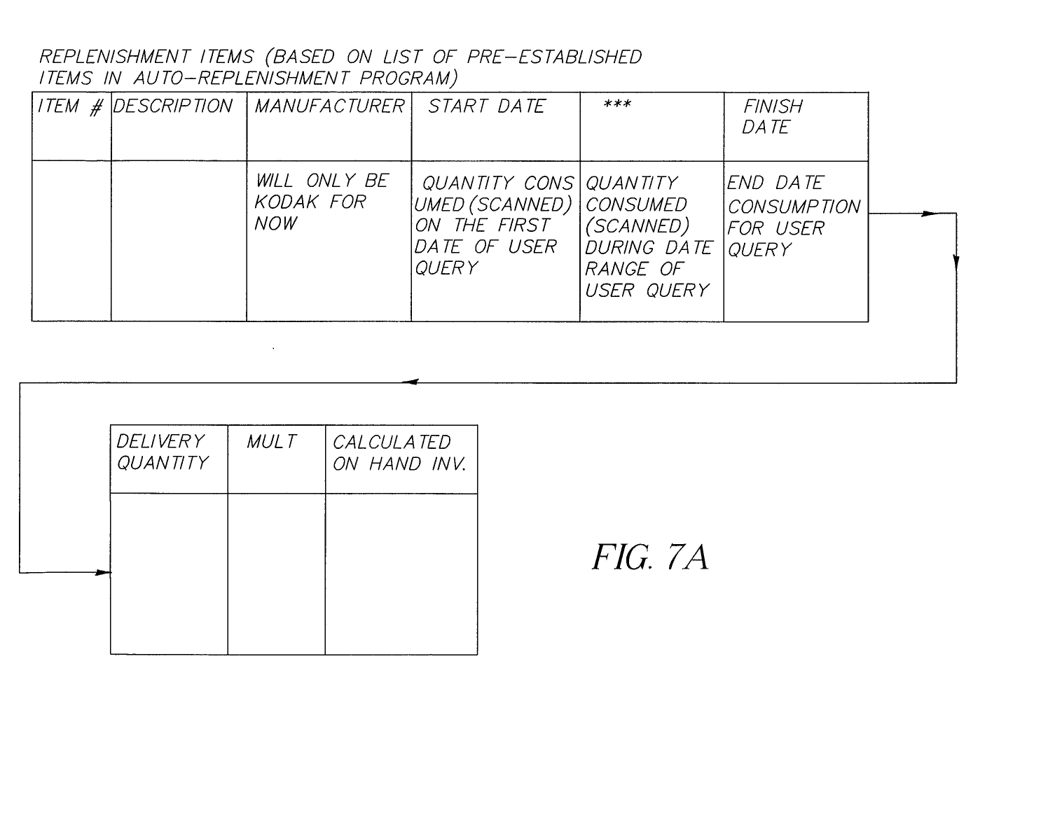

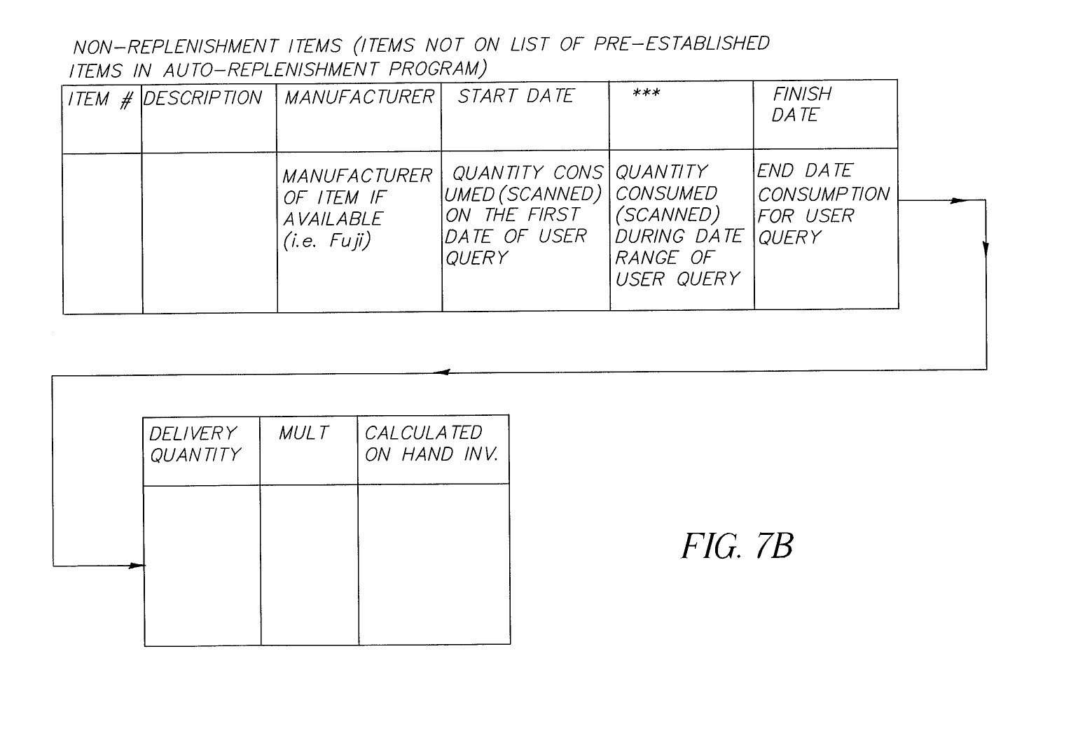

As information about the usage of products is collected, the dates for consumption of products should be recorded and subsequently stored in the database. This data can be used to generate consumption reports. Users may have the ability to review their consumption patterns via these reports. A range of dates for which customers wish to view product usage can be selected. The tables shown in FIG. 7 are examples of consumption reports which may be generated and shown to a user. The table can list items which are included in the automatic replenishment program, as well as items that are not included in the program or a combination of items that are selected by the user. The user can then select a start date and a finish date for which to view their consumption of products. For each date selected, the quantities consumed, that is, products that have been scanned, is shown in the table. Additionally, the delivery quantity, the multiple, as well as the calculated on-hand inventory may be shown for the selected products.

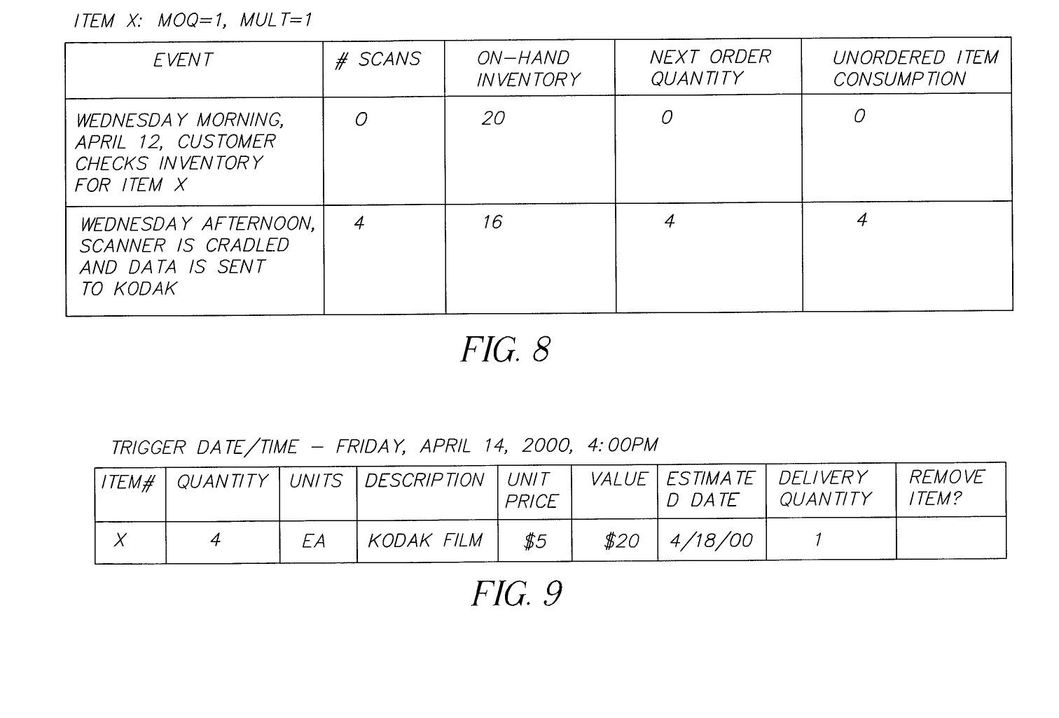

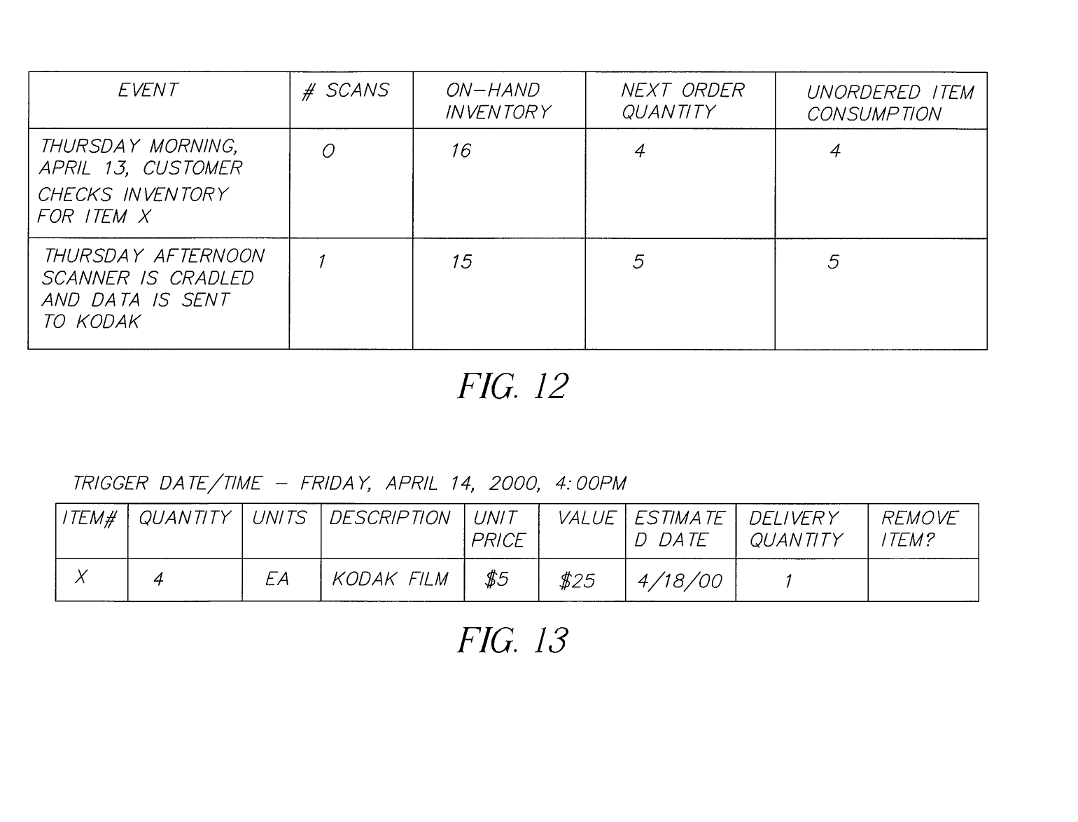

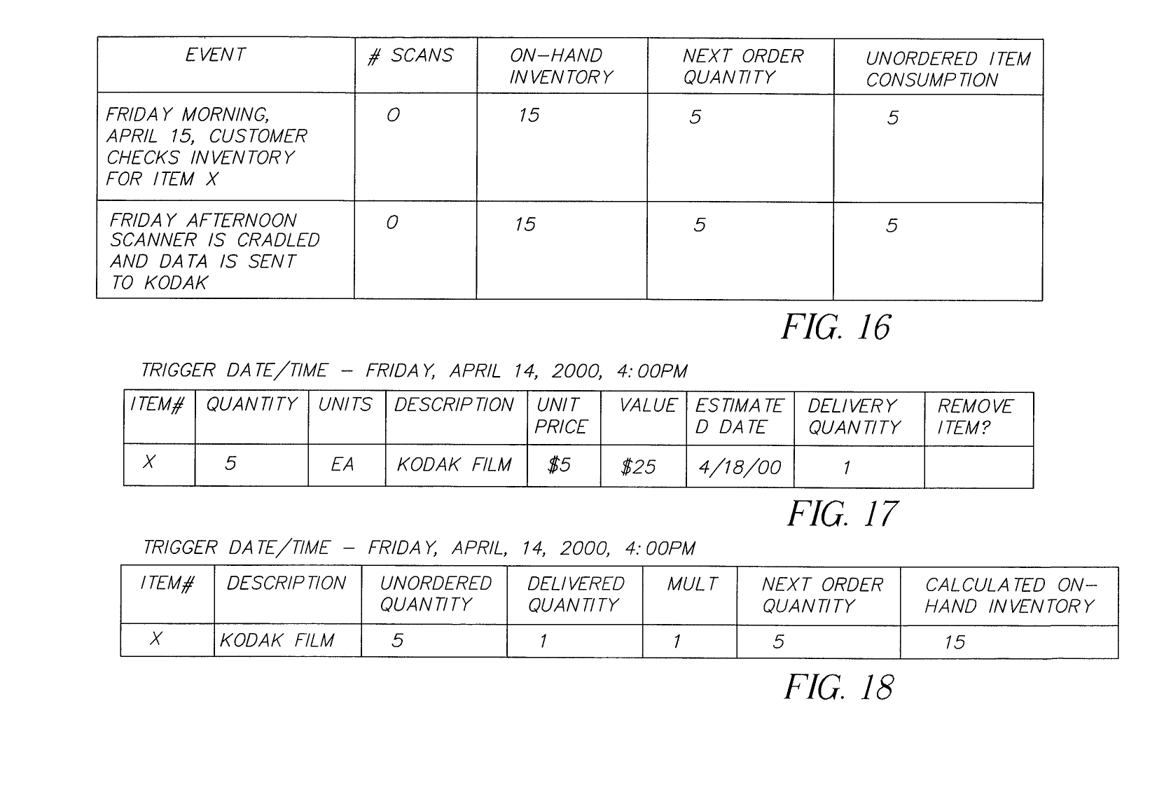

Turning now to FIGS. 8-20, an example scenario were over several days a customer scans products as they are used and the reports that may be generated and displayed to the user will be discussed. For this example, assume that MOQ=1 and MULT=1. At the beginning of the day in question, Wednesday, Apr. 12, 2000, the customer logs into the system and requests a report of his inventory. The server retrieves the inventory information for the customer from the database and provides it to the customer. Here, assume the customer has twenty items in their on-hand inventory. Throughout the day, various items are used and the barcodes on the items are scanned with a scanner as the items are used. At the end of the day, the scanner is connected to the client device. The usage information for the products used that day can then be uploaded to the server. On the date in question, four items were used. This usage information is uploaded and processed, for example, as described above. After the processing, an order entry screen for this particular example may look like the one shown in FIG. 9. At the top of the table, a trigger date and time is shown. Here, Apr. 14, 2000 at 4:00 pm has been selected as the order date. The various information for the products scanned is then displayed in the order entry screen. It has been determined based on the scanned information that Product X was used and it is described as Kodak film. The appropriate number for unit price, value, and estimate delivery date have also been provided in the table. The delivery quantity is set to the MOQ, 1.

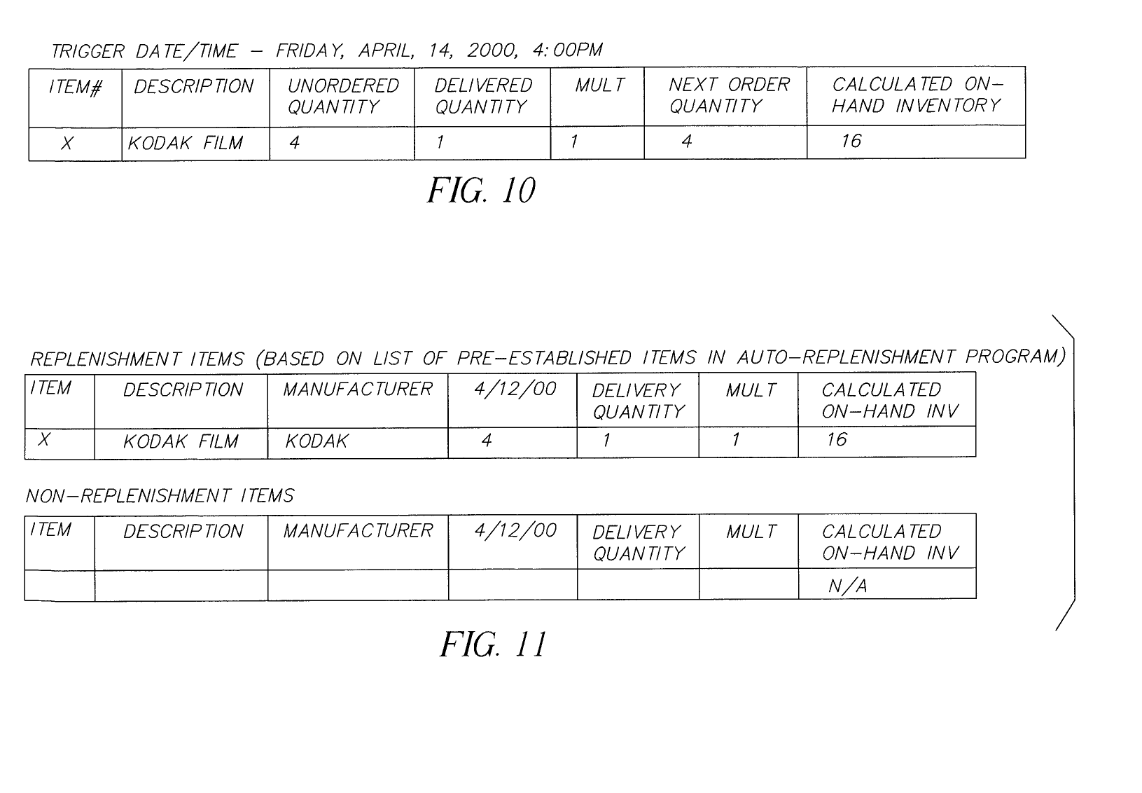

FIG. 10 shows an example order status screen. In the unordered quantity column,

4 is entered. This amount is equal to the total scans for the product X, (4), minus the total units ordered, at this point, (0). The MOQ, which is 1 in this example, is shown in the delivery quantity column and the multiple amount, which has been defined for this example as 1, is shown in the multiple column. To determine the next order quantity, the appropriate business rules should be applied. Using the business rules defined above, defining next order quantity as ((unordered quantity−MOQ)/MULT) * MOQ+MOQ, the calculated value of 4 is shown as the next order quantity.

FIG. 11 shows an example of a consumption report. In this example, the user has selected to their view consumption of products from Apr. 12, 2000 to the present. As the current date at this point in the example is April 12, only the consumption for that date is shown. Accordingly, the number of scans for products consumed, 4, is shown next to product X for that date. The calculated on-hand inventory, taking into account the products used that day, may also be shown. Thus, the current on-hand inventory in this case is 16.

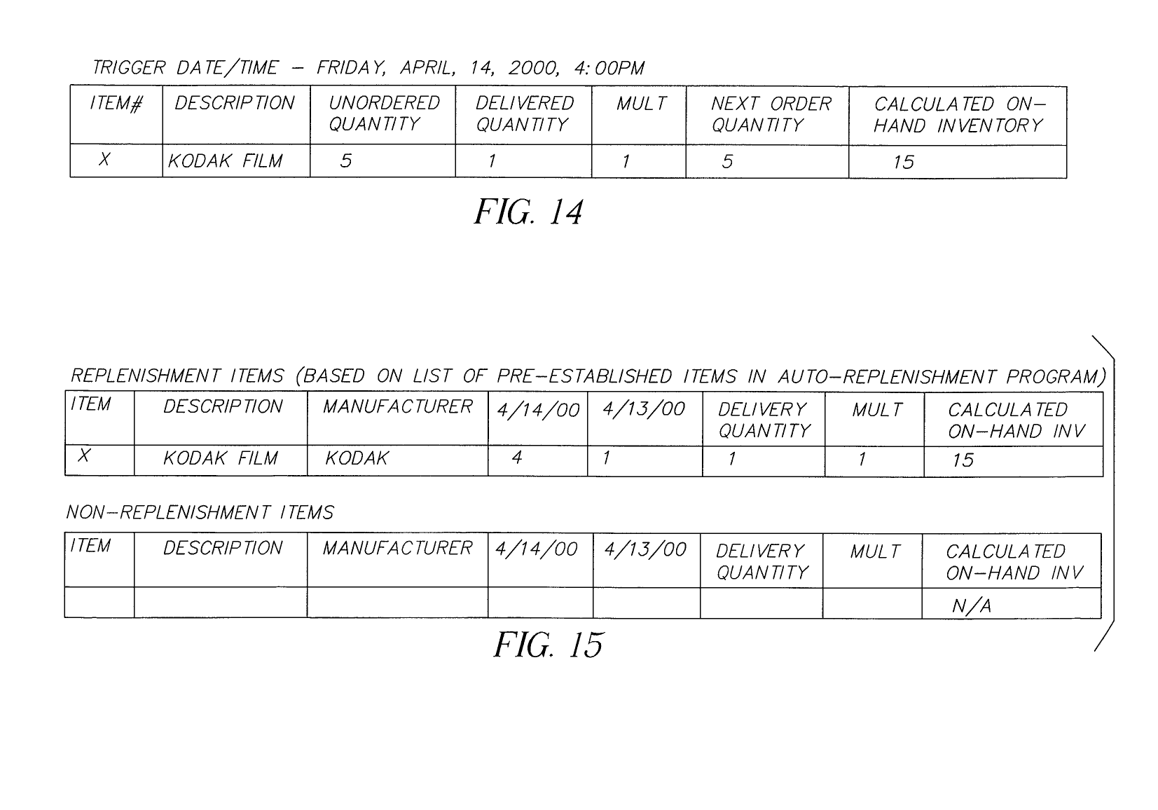

On Thursday morning April 13, the customer again checks their inventory for product X. At this point no product has been used on that date. Consequently, the on hand inventory remains 16, with 4 items having being used the previous day. Throughout the day Thursday as items are used, their barcodes are scanned. At the end of the day, the scanner is connected to the client device and the usage information is uploaded to the server. The usage data is processed and the inventory may then be updated. The order entry screen and the order status screen are updated to reflect the use of one additional product, product X, for a total of 5 units of product X used on April 12 and April 13. The order quantity and calculated on-hand inventory are also updated accordingly as shown in FIGS. 13, 14.

FIG. 15 shows a consumption report for April 12 to the present, April 13. These dates along with the appropriate usage data is displayed in the table. The amount of each product used is broken down and displayed based on the day it is used. Thus, April 12 indicates 4 units of product X were used and April 13 indicates 1 unit of product X was used.

On the next day, Friday morning April 14, the customer again check their inventory for product X. At this point, no product has been used and the on-hand inventory remains the same as it was the previous date. At the end of the day on Friday April 14, the scanner is again connected to the client device and usage data is uploaded to the server. Here, none of product X was used during the day, so no change is made to the data stored in the data base. Accordingly, the order entry screen and the order status remain the same, as shown in FIGS. 17, 18.

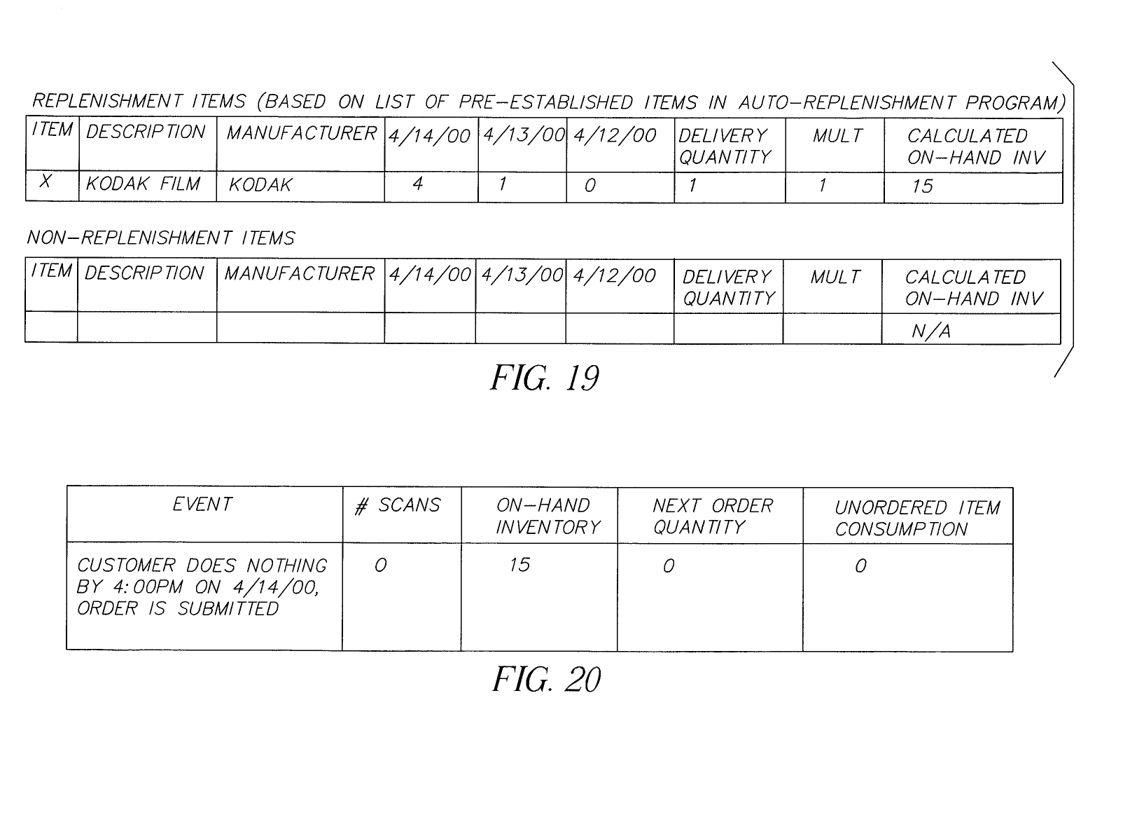

FIG. 19 shows a consumption report for April 12 through the present for all items. Accordingly, April 12 through the April 14 are listed with the appropriate number of items used on those dates displayed. Note that the trigger date and the time of Friday Apr. 14, 2000 4:00 pm is approaching. If the customer does not make any modifications, by 4:00 pm Apr. 14, 2000, the order shown in the order status screen is submitted. As mentioned above, the customer may have the choice of modifying the order screen before the trigger date and time. When the trigger date and time is reached, the modified order will be automatically submitted, as shown in FIG. 20. The order can be routed directly into the supplier's system with no manual intervention necessary. Also, electronic payment procedures may be automatically initiated after the order is placed.

Accordingly, an automatic consumption based inventory replenishment system has been provided. In one embodiment, at the customer end, the retail lab personnel scan the products as they use it, put the scanner on the cradle, and create the text file (using an application), then they initiate the upload. On the supplier end the text file is parsed, data is stored in the database, and displayed as report/for order entry, as required. The customer profile is administered at the supplier end. Additionally, the order entry to the supplier's order system, such as, SAP system can be done automatically.

Once the information is in the supplier systems, it can be viewed by the customer in predefined report format. New orders for the used products will automatically triggered (based on predefined business rules). The customer will have the option to edit the quantity of the products to be ordered. The customer may see the status of their orders online.

Additionally, usage of products is tracked as the customer consumes the products. A record of product usage is forwarded to the supplier, preferably at least daily. Based on the product usage, the supplier can know their customer's product needs and plan product manufacture and inventory accordingly.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

What is claimed is:

1. A method for automatically updating inventory, comprising:
a) providing a computer network, including one or more servers which are adapted to be accessed by a plurality of clients over the network;
b) receiving a record of the use of a product at the server;
c) parsing the record at the server to identify the products and a number of products used;
d) updating an inventory record in a database to reflect the use of the products, resulting in a current inventory level;
e) retrieving the current inventory level from the database; and
f) providing a consumption report including the current inventory level of products from the server to the client.

2. The method of claim 1, wherein step d) comprises:
retrieving a previous current inventory level for the product scanned; and
subtracting the number of products used from the inventory record, resulting in the current inventory level.

3. The method of claim 1, further comprising:
g) checking if an auto-replenish option is selected for a particular product;
h) if the auto-replenish option is selected, retrieving a threshold quantity for the particular product from the database;
i) comparing the threshold level with the current inventory level for the particular product; and
j) automatically ordering replacement product when the current inventory level is less than the threshold level.

4. The method of claim 1, further comprising:
creating the record of the use of the product when the product is used;
providing the record to the client; and
transmitting the record from the client over the network to the server.

5. The method of claim 4, wherein the creating step comprises scanning information from a bar code of a product as the product in consumed.

6. The method of claim 5, further comprising, with the client:
retrieving scanned information from the scanner;
extracting data, including at least one of a product code, scanner serial number, and a time date stamp, from the scanned information; and
creating a text file based on the extracted data.

7. In a computer network, including one or more servers which are adapted to be accessed by a plurality of clients over the network, a consumption based replenishment method, comprising:
providing an application to retrieve data including at least one of a product code, date stamp and scanner serial number from scanned information;
receiving the data from the clients at the server;
translating the data into catalog information and a product description at the server;
storing the translated data in a database;
determining a number of each product consumed based on the translated data;
applying business rules to calculate an order quantity for the product;
saving the order quantity for the product in the database; and
automatically placing an order for the order quantity based on the business rules.

8. The method of claim 7, further comprising:
scanning information from a bar code of a product as the product in consumed;
transferring the scanned information to the client device; and
transmitting the scanned information to the server.

9. The method of claim 7, further comprising:
updating an inventory record for the customer to reflect the number of each product consumed; and
storing the updated inventory in the database;

10. The method of claim 7, further comprising:
accessing the database to obtain product usage information for a customer;
generating a usage report based on the product usage information with a software application; and
providing the report to the client.

11. The method of claim 7, further comprising:
a) retrieving the order quantity from the database;
b) providing the order quantity to the client upon request;
c) allowing the client to modify the order quantity; and
d) applying the business rules to the modified order quantity.

12. The method of claim 11, further comprising performing steps a)-d) for only those product that are specified to be auto-replenished.

13. The method of claim 7, wherein the retrieving step comprises creating a text file based on the scanned information.

14. The method of claim 13, wherein the translating step comprises parsing the text file.

15. The method of claim 7, further comprising:
storing a catalog of products on the database; and
storing customer selected products from the catalog to be automatically replenished.

16. In a manufacturing system including one or more servers which are adapted to be accessed by a plurality of clients over a network, customers being able to communicate via the client with a supplier on the server side, each customer creating a record of use of products indicating when the products are used, a method for managing manufacturing products, comprising:
a) receiving the records from the client at the server on at least a daily basis,
b) evaluating the records for all customers at the server; and
c) setting a manufacturing schedule for the supplier based on the evaluation.

17. The method of claim 16, further comprising:
associating a user ID with the records submitted;
retrieving a catalog number and description from a database for each record; and
storing the catalog number and description in a customer database associated with the customer ID.

18. The method of claim 17, further comprising updating inventory at the server for each customer based on the records.

19. The method of claim 16 wherein, the evaluation step determines a number and type of product used.

20. A consumption based replenishment method, comprising:
scanning information from a bar code of a product as a product is consumed;
transferring the scanned information to a client device; and
retrieving data including at least one of a product code, time/date stamp and scanner serial number from the scanned information.

21. The method of claim 20, further comprising:
accessing a web site on a server;
entering a user ID and password;
selecting records to upload; and
submitting the records from the client device to the server.

22. A method for consumption based replenishment of products, comprising:
a) creating a record of use of a product, the record indicating when the product is consumed;
b) forwarding the record to a manufacturer;
c) evaluating the record; and
d) manufacturing replacement product based on the evaluation.

23. The method of claim 22, wherein step a) comprises:
scanning at a customer location a barcode of the product;
translating the barcode into the record; and
storing the record on a client device.

24. The method of claim 22, wherein the record is forwarded at least daily.

25. The method of claim 22, wherein the record is a text file.

26. The method of claim 22, wherein step b) comprises transmitting the record from a client device over a network to a server.

27. The method of claim 26, wherein the record is stored in a database accessible by the server.

28. The method of claim 22, wherein step c) comprises parsing the record to determine a type of product used.

29. The method of claim 28, wherein records are forwarded from a plurality of customer locations.

30. The method of claim 29, further comprising:
combining records from the plurality of customer locations to determine a number of the type of product used; and
determining how many replacement products to produce based on the number of that type of product used.

31. The method of claim 30, wherein the determination is made based on business rules.

32. The method of claim 30, wherein the evaluation is performed for products used during a specified period of time.

33. The method of claim 22, further comprising adjusting an inventory of the manufacturer based on the evaluation.

34. The method of claim 22, further comprising resupplying a customer with replacement product based on the evaluation.

35. In a supply distribution chain wherein customers create a record of use of a product indicating when the product is consumed, a method for consumption based replenishment of products, comprising:
receiving the record at a manufacturer;
evaluating the record to determine when the product is used; and
manufacturing replacement product based on the evaluation

36. The method of claim 35 wherein the evaluation step also determines an amount of product is used.

37. The method of claim 35, wherein step c) comprises parsing the record to determine a type of product used.

38. The method of claim 35, wherein records are forwarded from a plurality of customer locations.

39. The method of claim 38, further comprising:
combining records from the plurality of customer locations to determine an amount of the type of product used at the plurality of customer locations; and
determining how many replacement products to produce based on the amount of that type of product used.

40. The method of claim 39, wherein the determination is made based on business rules.

41. The method of claim 38, wherein the evaluation is performed for products used during a predetermined period of time.

42. A computer useable information storage medium storing computer readable program code for causing a computer to perform the steps of:
receiving a record of use of products at a manufacturer;
determining types of products used based on the record;
determining a date of use of the products based on the record;
determining a number of each type of product used; and
planning manufacture of the types of products based on at least one of the number of each type of product used and the date of use of the product.

43. The computer useable storage medium of claim 41, wherein the record is a text file.

44. The computer useable storage medium of claim 42, wherein the determining steps comprise parsing the text file.
